(19) United States
(12) Patent Application Publication
(10) Pub. No.: US 2018/0069434 A1
(43) Pub. Date: Mar. 8, 2018

(54) FILTER CIRCUIT AND WIRELESS POWER TRANSMISSION SYSTEM

(71) Applicant: Kabushiki Kaisha Toshiba, Minato-ku (JP)

(72) Inventor: Kohei HASEGAWA, Minato-ku (JP)

(73) Assignee: Kabushiki Kaisha Toshiba, Minato-ku (JP)

(21) Appl. No.: 15/695,676

(22) Filed: Sep. 5, 2017

(30) Foreign Application Priority Data
Sep. 5, 2016 (JP) 2016-172779

(51) Int. Cl. H02J 50/12; H02M 3/22

(52) U.S. Cl. CPC H02J 50/12; H02M 3/22

(57) ABSTRACT

A filter circuit includes: a first coil electromagnetically coupled to a current-carrying coil inserted into a current flow path; and a parallel circuit of a second coil and a capacitor, the parallel circuit being connecting across the first coil. The element constants of the second coil and the capacitor are set such that parallel resonance occurs at a frequency at which an impedance between the terminals of the current-carrying coil is equivalent to an impedance of the current-carrying coil alone.

### BACKGROUND OF THE INVENTION

### Field of the Invention

Embodiments of the present invention relate to a filter circuit provided for a current-carrying coil inserted into a current flow path, and a wireless power transmission system provided with the current-carrying coil and the filter circuit.

### Description of the Related Art

For example, Japanese Patent Laid-Open No. 2013-247822 discloses a wireless power transmission system including a power transmitting coil and a power receiving coil that are electromagnetically coupled to each other. In this system, an electromagnetic signal radiated with a frequency component other than a frequency for power transmission may cause noise in environments. Thus, measures implemented against noise need to satisfy an acceptable standard level.

In this system, the power transmitting coil cannot be shielded and thus measures are ordinarily implemented using a filter circuit. However, the filter circuit disposed in a current flow path inevitably affects impedance matching so as to reduce power transmission efficiency and thus the measures are not always satisfactory.

### BRIEF DESCRIPTION OF THE DRAWINGS

FIG. 1 illustrates the configuration of a power transmission system according to a first embodiment;

FIG. 2 illustrates the electrical configuration of a filter circuit;

FIG. 3 is an explanatory drawing (1) showing the effect of the filter circuit;

FIG. 4 is an explanatory drawing (2) showing the effect of the filter circuit;

FIG. 5 is a perspective view illustrating a multilayer substrate structure having a power transmitting coil and a coil L1;

FIG. 6 illustrates a surface of an insulating layer where the power transmitting coil is formed;

FIG. 7 illustrates a surface of the insulating layer where the coil L1 is formed;

FIG. 8 is a cross-sectional view illustrating a model a multilayer substrate configuration;

FIG. 9 shows the constants of circuit elements used for simulation;

FIG. 10 is a voltage spectrum diagram showing simulation results in the absence of the filter circuit;

FIG. 11 is a voltage spectrum diagram showing simulation results in the presence of the filter circuit;

FIG. 12 shows a voltage reduction level obtained by the filter circuit;

FIG. 13 shows fluctuations in current level and phase depending on the presence or absence of the filter circuit;

FIG. 14 shows a distant field pattern in the presence of the power transmitting coil alone;

FIG. 15 shows a distant field pattern when the coil L1 is electromagnetically coupled to the power transmitting coil;

FIG. 16 shows fluctuations in radiation electric field strength depending on the presence or absence of the filter circuit;

FIG. 17 shows fluctuations in radiation electric field strength when a distance d between the facing coils is changed;

FIG. 18 shows fluctuations in radiation electric field strength when the distance d between the facing coils is fixed and the time constant of an LC parallel resonator is changed;

FIG. 19 illustrates a configuration including a filter circuit used for a coaxial cable according to a second embodiment; and

FIG. 20 shows a configuration including a filter circuit with a neutral point according to a third embodiment.

### DETAILED DESCRIPTION OF THE EMBODIMENT

The present embodiment provides a filter circuit that can reduce influence on the impedance of a current flow path, and a wireless power transmission system including the filter circuit.

The filter circuit according to an embodiment includes: a first coil electromagnetically coupled to a current-carrying coil inserted into a current flow path; and

a parallel circuit having a second coil and a capacitor, the parallel circuit being connected across the first coil,

wherein the element constants of the second coil and the capacitor are set such that parallel resonance occurs at a frequency where an impedance between the terminals of the current-carrying coil is equivalent to the impedance of the current-carrying coil alone.

A wireless power transmission system according to the embodiment includes:

a power transmitter provided with the filter circuit according to the embodiment with the current-carrying coil serving as a power transmitting coil; and

a power receiver provided with the filter circuit according to the embodiment with the current-carrying coil serving as a power receiving coil.

### First Embodiment

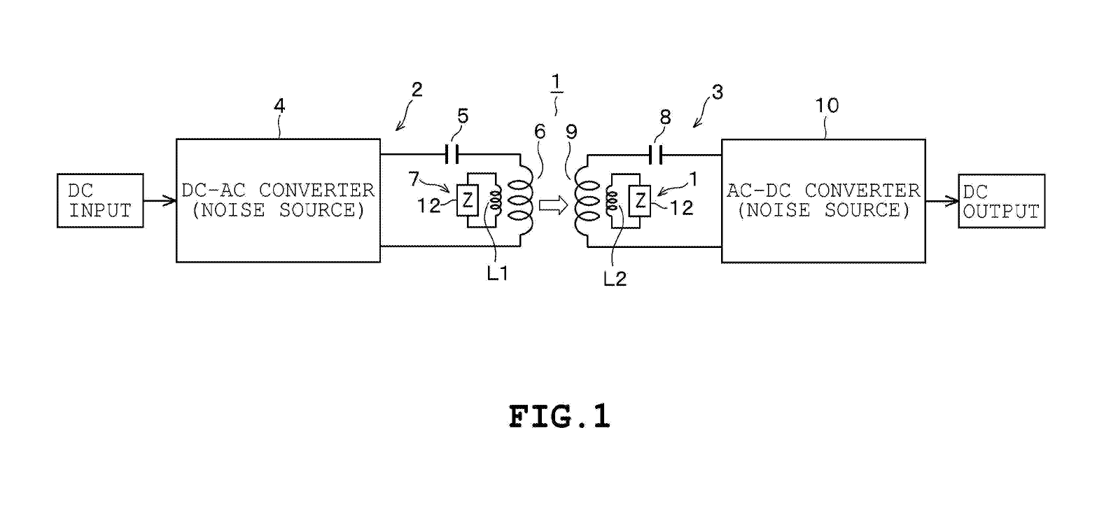

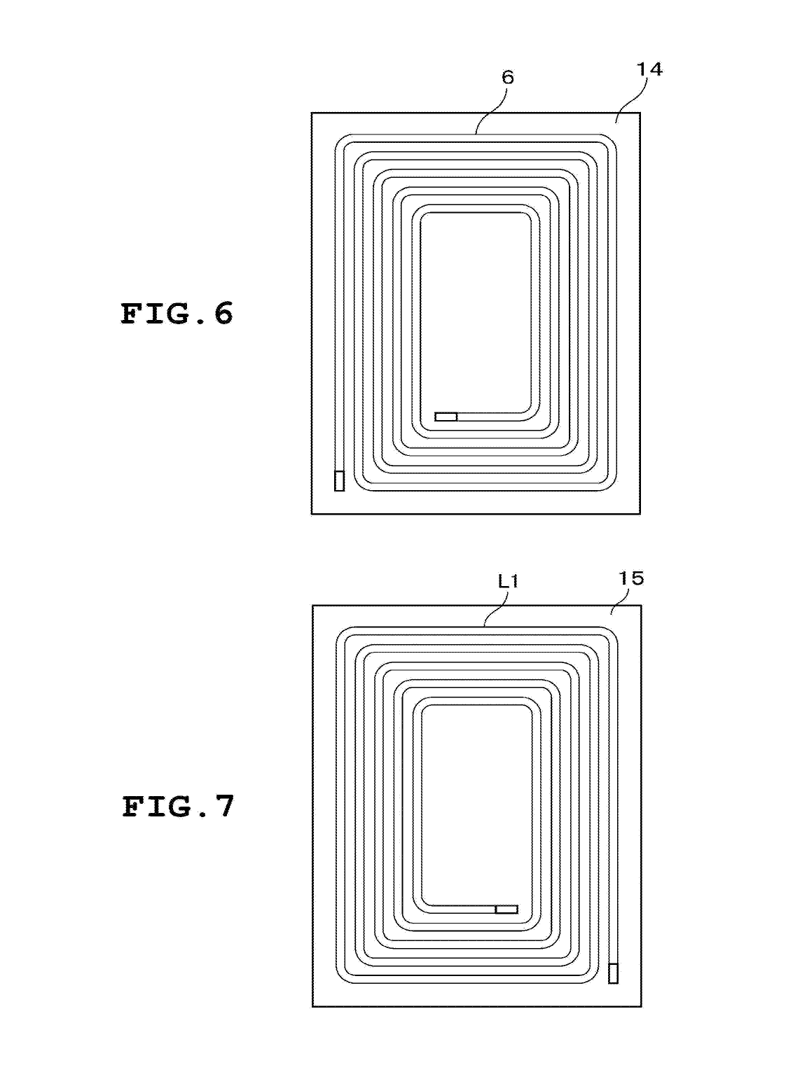

Referring to FIGS. 1 to 18, a first embodiment will be described below. FIG. 1 illustrates the configuration of a power transmission system according to the present embodiment. The power transmission system 1 includes a power transmitter 2 and a power receiver 3. The power transmitter 2 includes a DC-AC converter 4 that converts inputted direct-current power into alternating-current power and a series circuit having a capacitor 5 and a power transmitting coil 6 that are connected between the output terminals of the DC-AC converter 4. Furthermore, the power transmitter 2 includes a filter circuit 7 electromagnetically coupled to the power transmitting coil 6.

The power receiver 3 includes a series circuit having a capacitor 8 and a power receiving coil 9 and an AC-DC converter 10, the series circuit being connected between the input terminals of the AC-DC converter 10. The AC-DC converter 10 converts inputted alternating power into direct-current power and then outputs the converted power. Likewise, the power receiver 3 includes a filter circuit 11 electromagnetically coupled to the power receiving coil 9. The DC-AC converter 4 and the AC-DC converter 10 also serve as noise sources in the power transmission system 1.

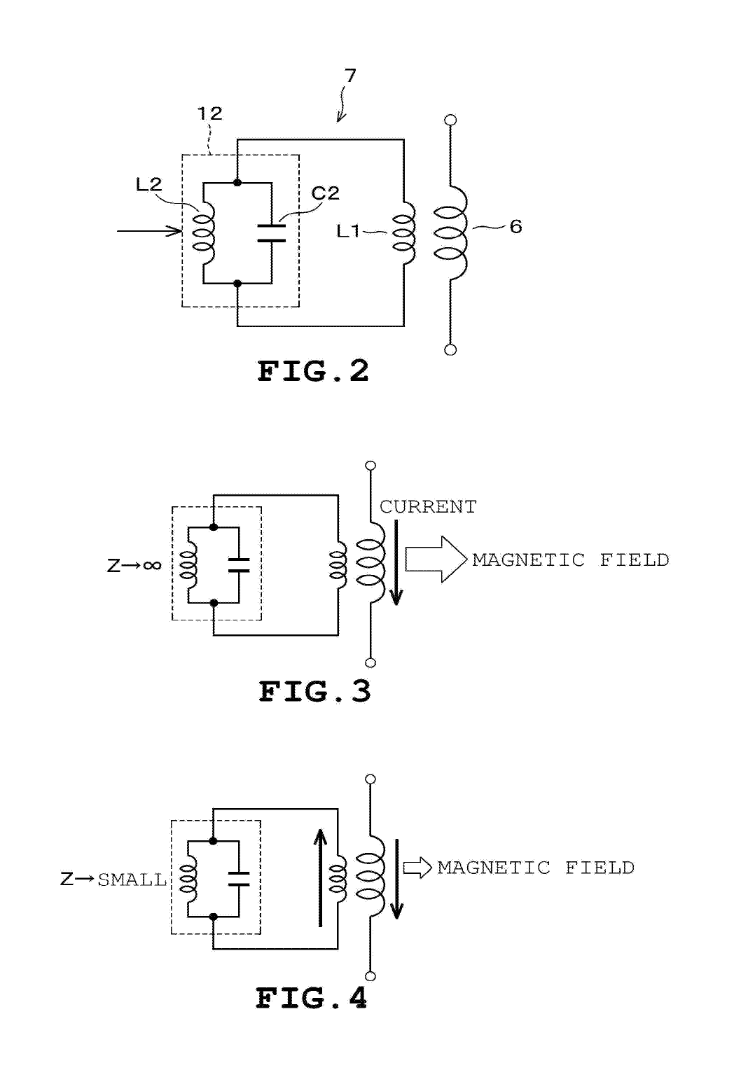

The filter circuits 7 and 11 are identical in configuration. Referring to FIG. 2, the filter circuit 7 will be discussed below. The filter circuit 7 includes a coil L1 electromagnetically coupled to the power transmitting coil 6 and an LC parallel resonator 12 including a coil L2 and a capacitor C2 that are parallel-connected to the coil L1. The time constant of the LC parallel resonator 12 is selected so as to have a maximum impedance at the power transmission frequency of the power transmitter 2, e.g., 6.78 MHz. The power transmitting coil 6 corresponds to a current-carrying coil. The coils L1 and L2 correspond to first and second coils, respectively.

Thus, as shown in FIG. 3, an excitation current is not generated on the coil L1 at a transmission frequency. In other words, filtering is not performed and thus a loss of power transmitted to the power receiver 3 is eliminated. As shown in FIG. 4, in a frequency region higher than the transmission frequency, the impedance of the LC parallel resonator 12 decreases and an excitation current in inverted phase passes through the coil L1. This allows a magnetic field generated on the coil L1 to cancel out a magnetic field generated on the power transmitting coil 7, enabling filtering.

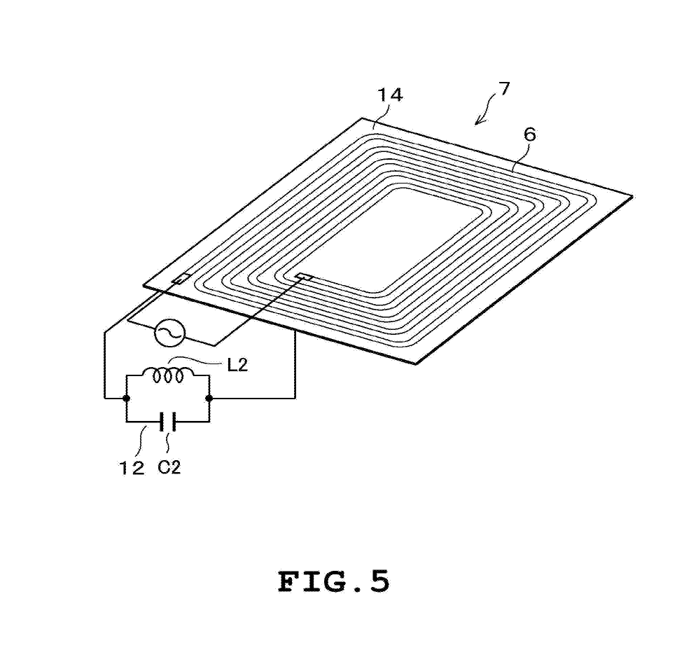

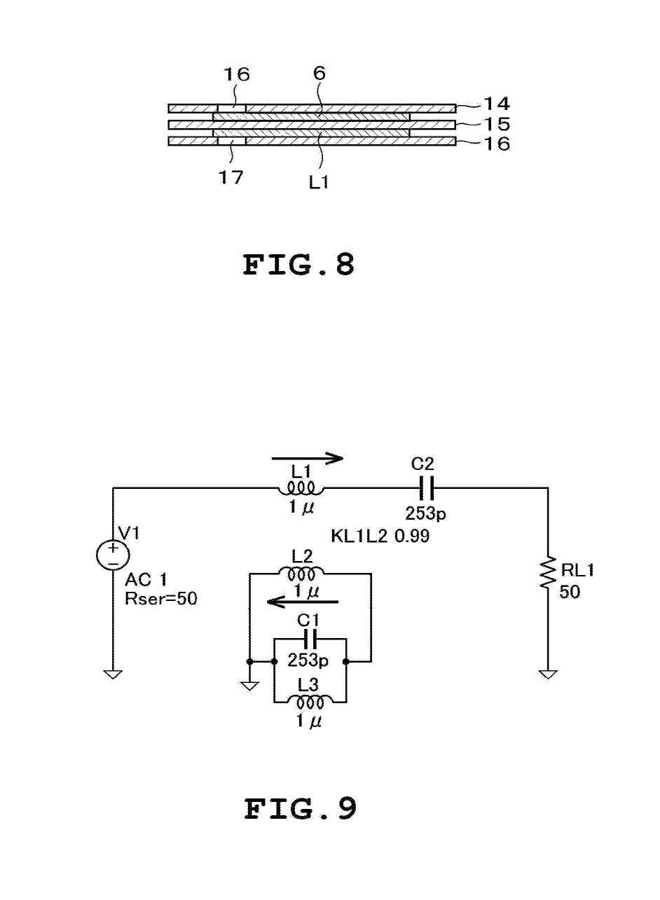

FIGS. 5 to 8 show the physical configuration of the filter circuit 7. In the filter circuit 7, the pattern of the power transmitting coil 6 is formed on the front side of an insulating layer 13 serving as a substrate and the pattern of the coil L1 is formed on the back side of the insulating layer 13. As shown in FIG. 8, a protective layer 14 is disposed on the power transmitting coil 6 and a protective layer 15 is disposed also under the coil L1. In other words, these layers and coils constitute a multilayer substrate. The protective layer 14 has openings 16 for connecting both ends f the power transmitting coil 6 to the output terminals of the DC-AC converter 4. Similarly, the protective layer 15 has openings 17 for connecting both ends of the coil L1 to both ends of the LC parallel resonator 12.

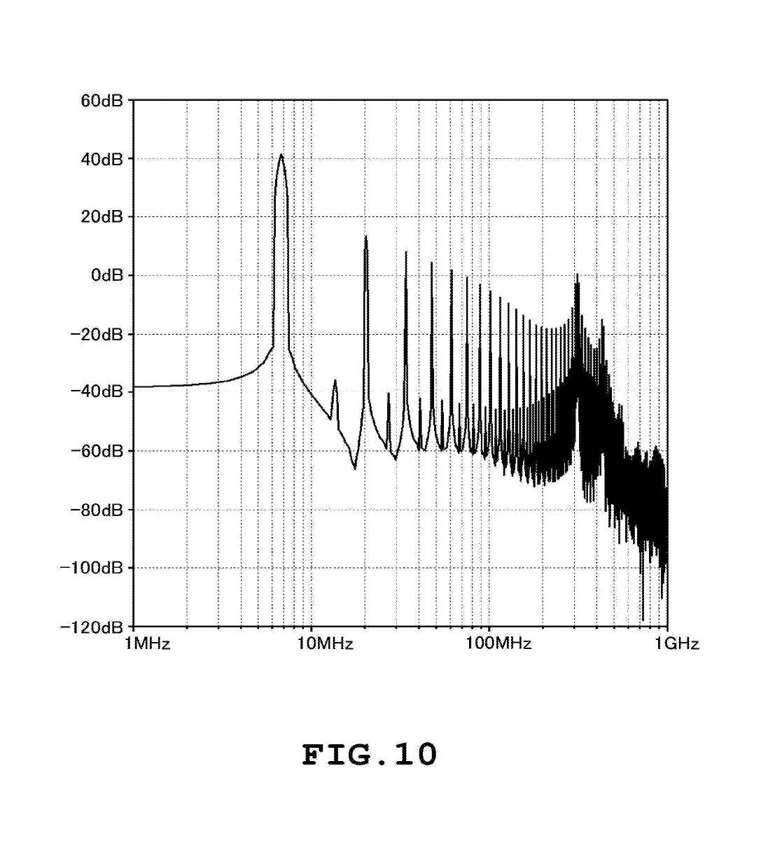

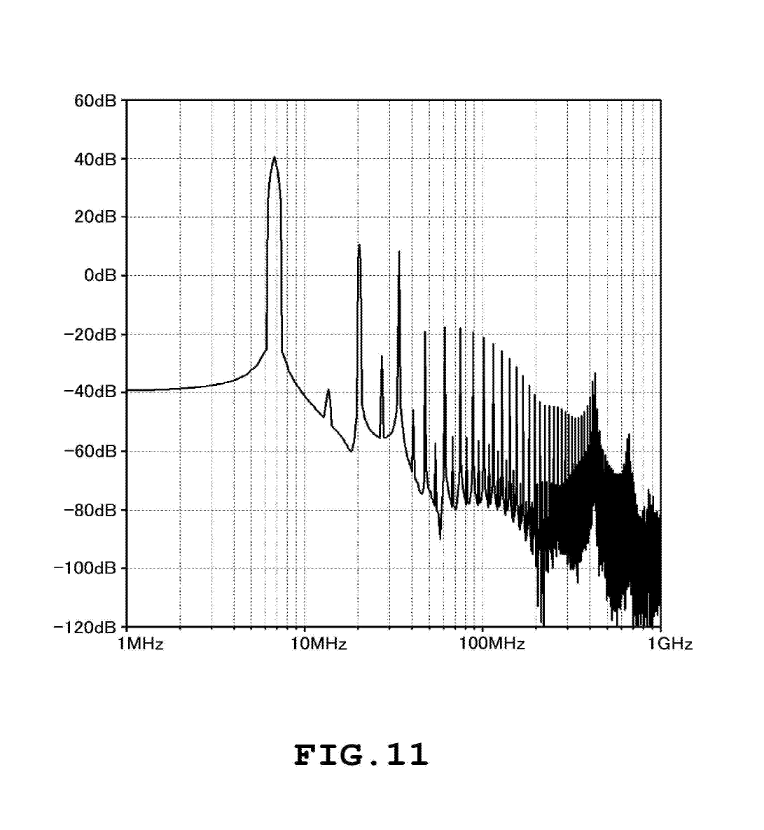

The effects of the filter circuits 7 and 11 of the present embodiment will be discussed below according to simulation results. The power transmitting coil 6 and the coil L1 that are identical in shape are patterned with, for example, a line width of 2.5 mm and an inductance of 1 μH. If a clearance between the facing coils, that is, the thickness of the insulating layer 13 is 0.1 mm, a coupling coefficient k is 0.97 to 0.98. If the clearance is changed to 0.025 mm, the coupling coefficient k is 0.99. FIG. 9 shows the constants of circuit elements used in the simulation. In FIG. 9, reference character L1 corresponds to the power transmitting coil 6 of the present embodiment and reference character L2 corresponds to the coil L1 of the present embodiment. In this case, as shown in FIGS. 10 and 11, any loss is not found at a transmission frequency of 6.78 MHz and a noise level is lowered by filtering in a higher frequency region.

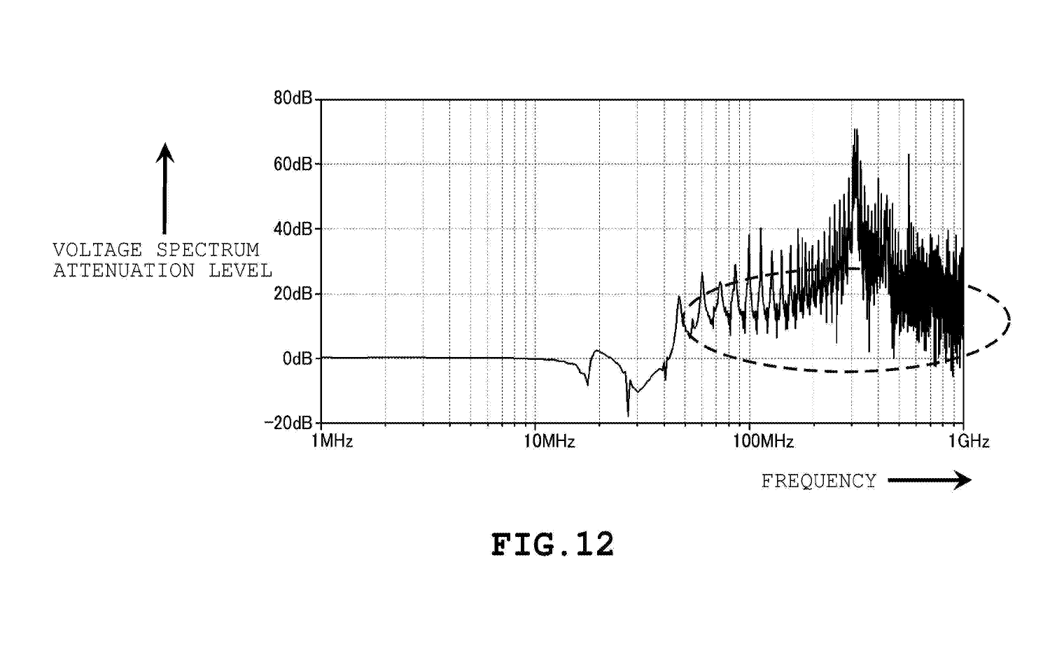

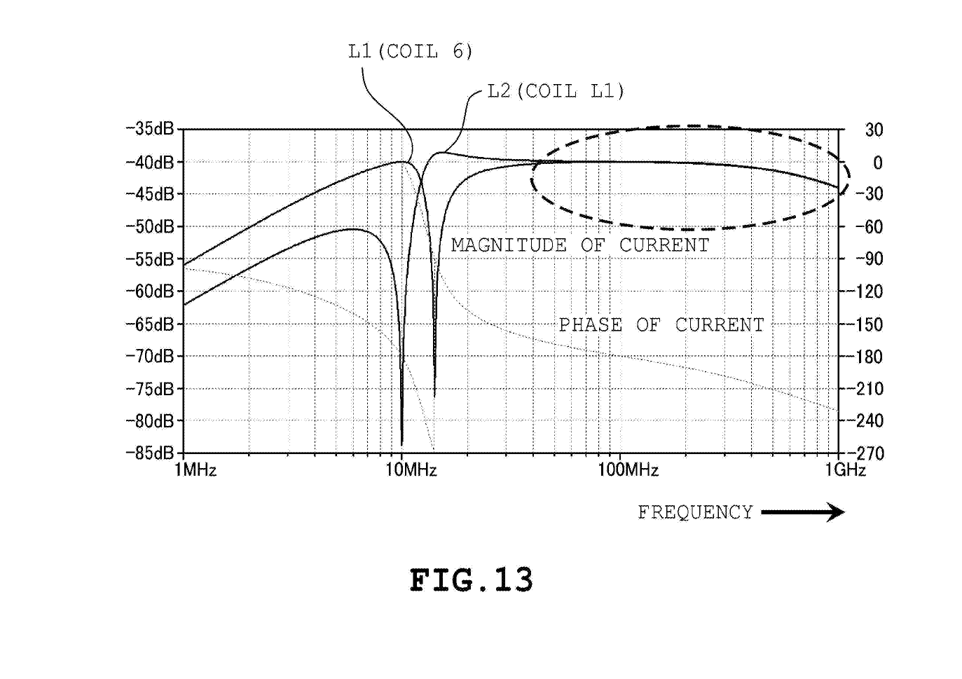

FIG. 12 shows a voltage attenuation level obtained by the effect of the filter circuit 7 between FIG. 10 and FIG. 11. Attenuation is not substantially found until a frequency of 10 MHz, attenuation appears at a frequency higher than 40 MHz, and an attenuation level peaks at a frequency exceeding 300 MHz. FIG. 13 shows the magnitudes of currents passing through the power transmitting coil 6 and the coil L1 and a current phase difference between the coils. The currents are equal to each other at a frequency exceeding 50 MHz with a phase difference of about 180°, enabling filtering.

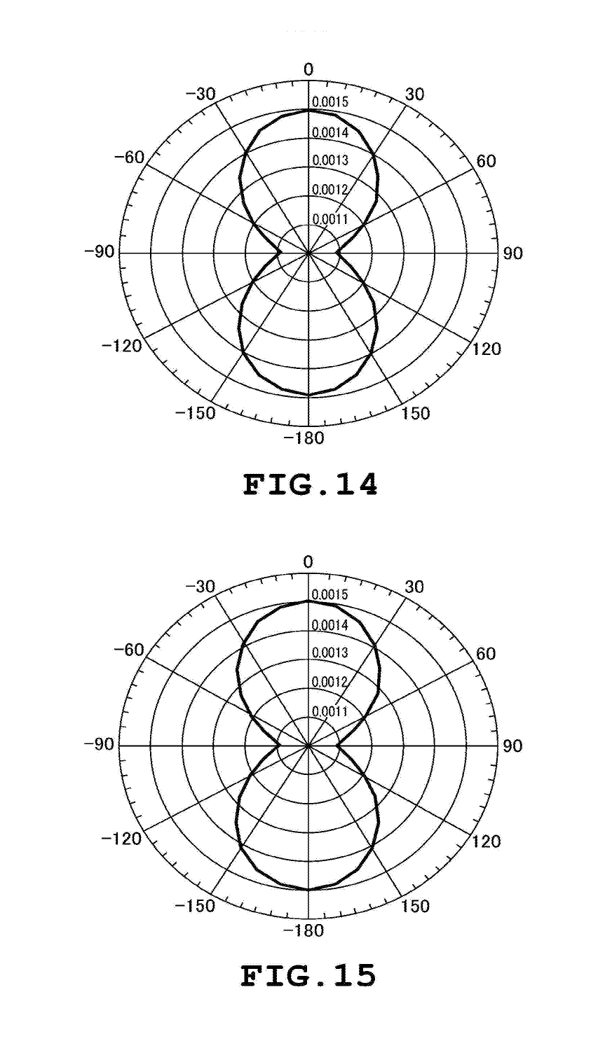

FIGS. 14 and 15 respectively show distant field patterns at a frequency of 6.78 MHz in the presence and absence of the filter circuit 7. It is understood that the distant field patterns are hardly affected by the presence or absence of the filter circuit 7.

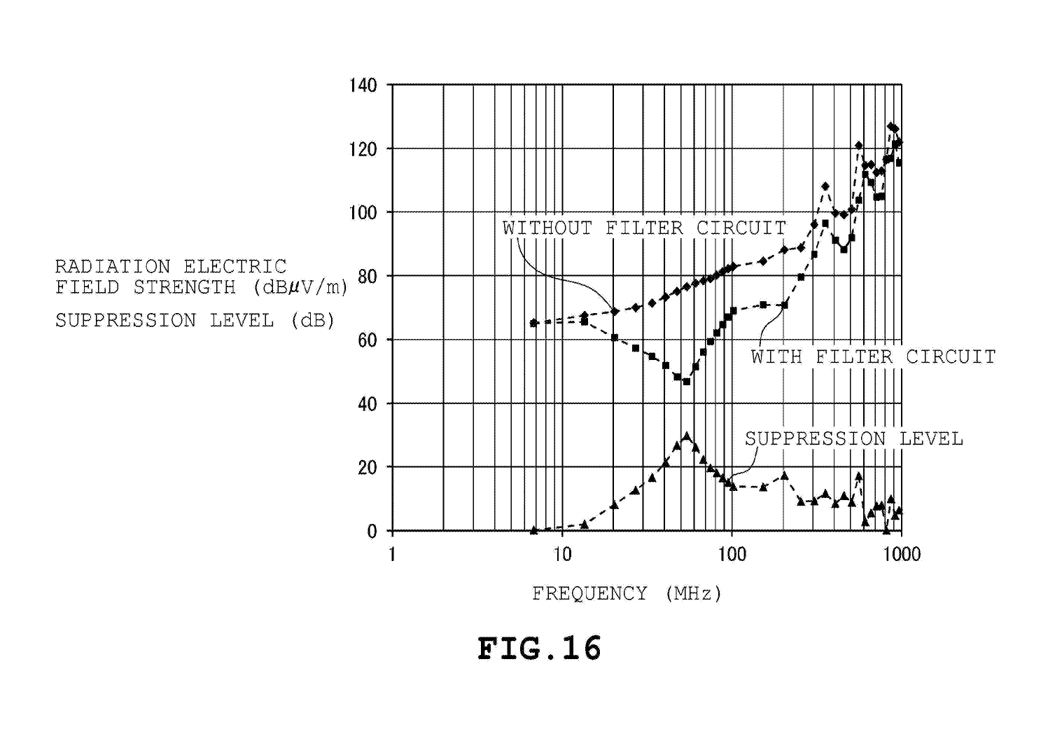

FIG. 16 shows a radiation electric field strength [dBμV/m] and a radiation electric field suppression level [dB] in the presence and absence of the filter circuit 7 when the power transmitting coil 6 and the coil L1 each have an inductance of 1.3 μH, the capacitors 5 and C2 each have a capacity of 425 pF, and a distance d between the facing coils is 25 μm. The radiation electric field strength is not affected at a transmission frequency of 6.78 MHz. The suppression level increases at a frequency exceeding 10 MHz.

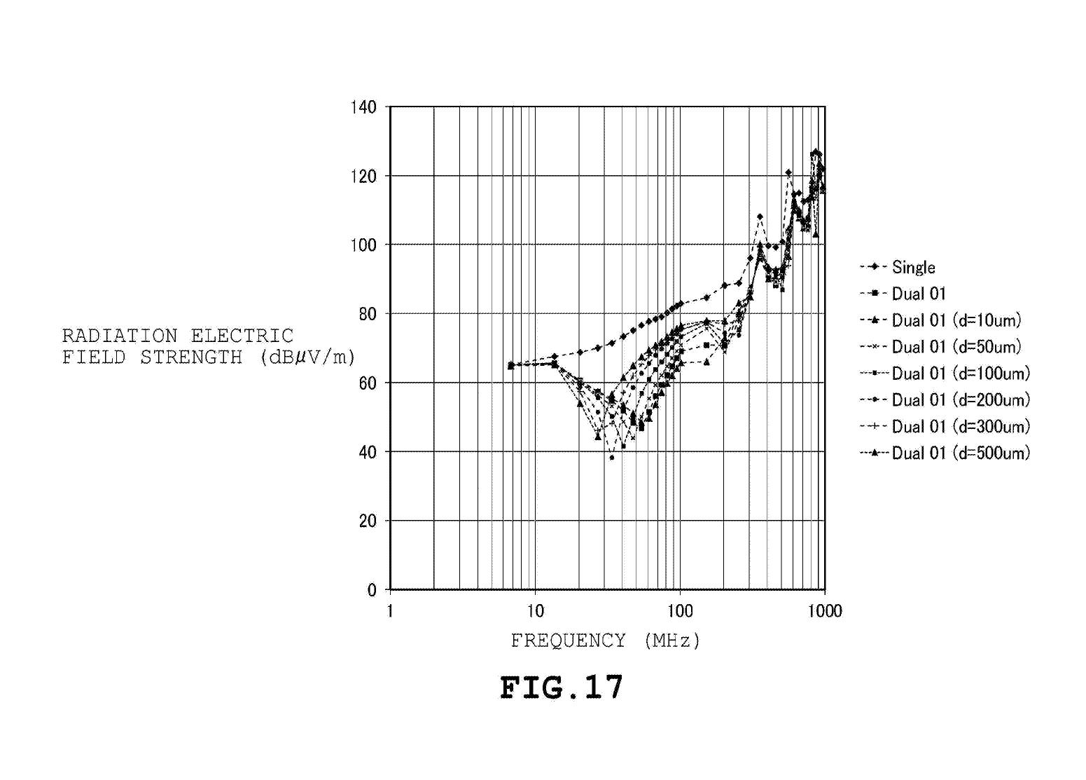

FIG. 17 shows fluctuations in radiation electric field strength when the distance d between the facing coils is changed. In the case of d=200 μm, the suppression level is maximized around a frequency of 30 MHz. The distance d between the facing coils is reduced to raise the coupling coefficient k, achieving the effect of suppressing noise over a wide frequency band.

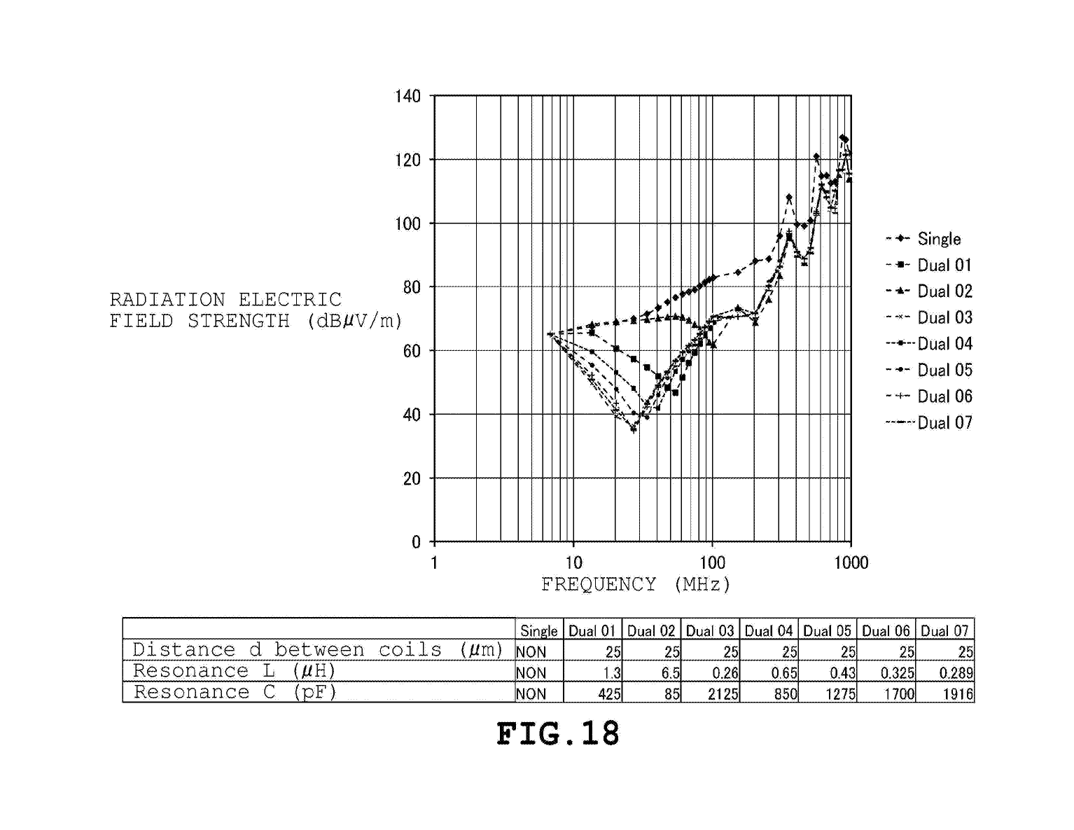

FIG. 18 shows fluctuations in radiation electric field strength when the distance d between the facing coils is fixed at 25 μm and the time constant of the LC parallel resonator 12 is changed. As the inductance of the coil L2 decreases, noise is suppressed from a lower frequency.

As described above, according to the present embodiment, the filter circuit 7 includes the coil L1 electromagnetically coupled to the power transmitting coil 6 inserted into the current flow path of the power transmitter 2 and the parallel circuit 12 having the coil L2 and the capacitor C2 that are connected across the coil L1. The element constants of the coil L2 and the capacitor C2 are set such that parallel resonance occurs at an arbitrary frequency where an impedance between the terminals of the power transmitting coil 6 is equivalent to an impedance of the coil 6 alone. In other words, the time constant of the LC parallel resonator 12 is selected so as to have a maximum impedance at the frequency, that is, when the power transmitter 2 has a power transmission frequency of 6.76 MHz.

This can filter noise at a higher frequency without providing attenuation for an electromagnetic signal of a frequency used for power transmission. At this point, the inductance of the coil L2 is set equal to or less than the inductance of the coil L1, thereby improving the effect of filtering.

Moreover, the coil L1 is disposed on one side of the insulating layer 13 while the power transmitting coil 6 is disposed on the other side of the insulating layer 13. Thus, a clearance between the power transmitting coil 6 and the coil L1 facing each other can be easily adjusted according to the thickness of the insulating layer 13. This can easily adjust the level of electromagnetic coupling of the coil L1 to the power transmitting coil 6. Furthermore, the filter circuits 7 and 11 are applied to the wireless power transmission system 1 including the power transmitter 2 and the power receiver 3, thereby transmitting power with high efficiency.

### Second Embodiment

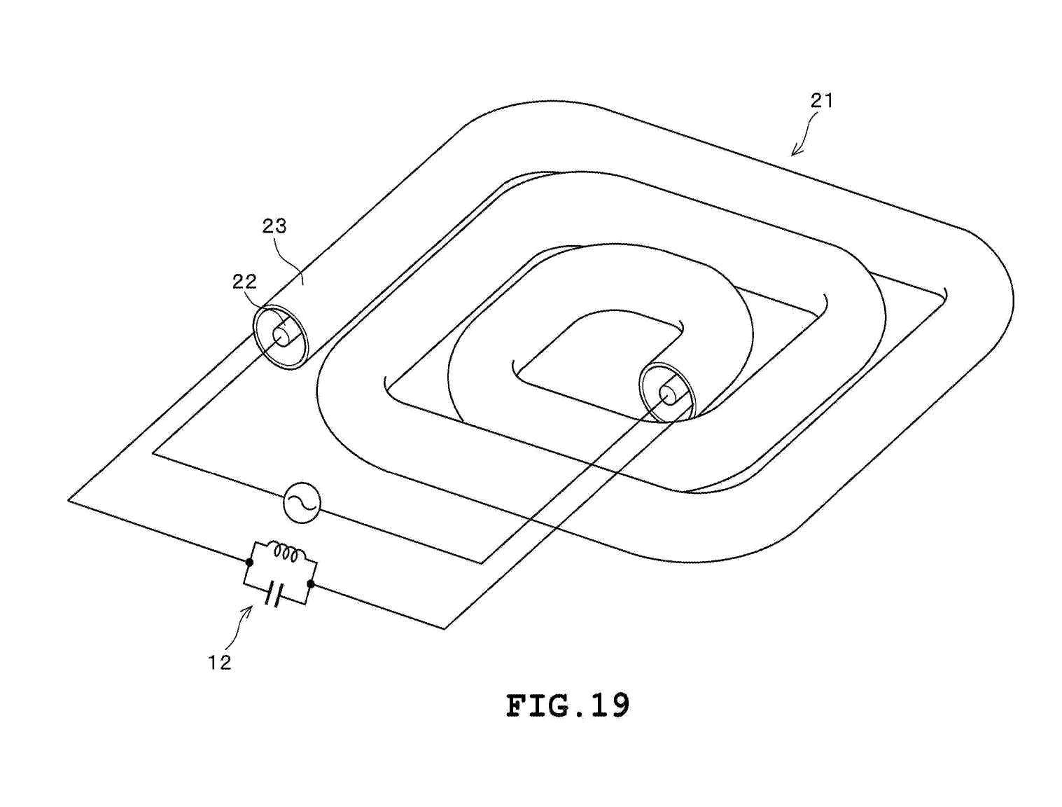

In the following description, the same parts as in the first embodiment are indicated by the same reference numerals and the explanation thereof is omitted. Different parts will be discussed below. As shown in FIG. 19, in a second embodiment, a filter circuit includes a central conductor 22 serving as the internal conductor a coaxial cable 21 and a sheath conductor 23 serving as the external conductor of the coaxial cable 21. For example, an LC parallel resonator 12 is connected such that the central conductor 22 serves as a current-carrying coil and the sheath conductor 23 serves as a coil L1 constituting the filter circuit. The relationship may be reversed.

### Third Embodiment

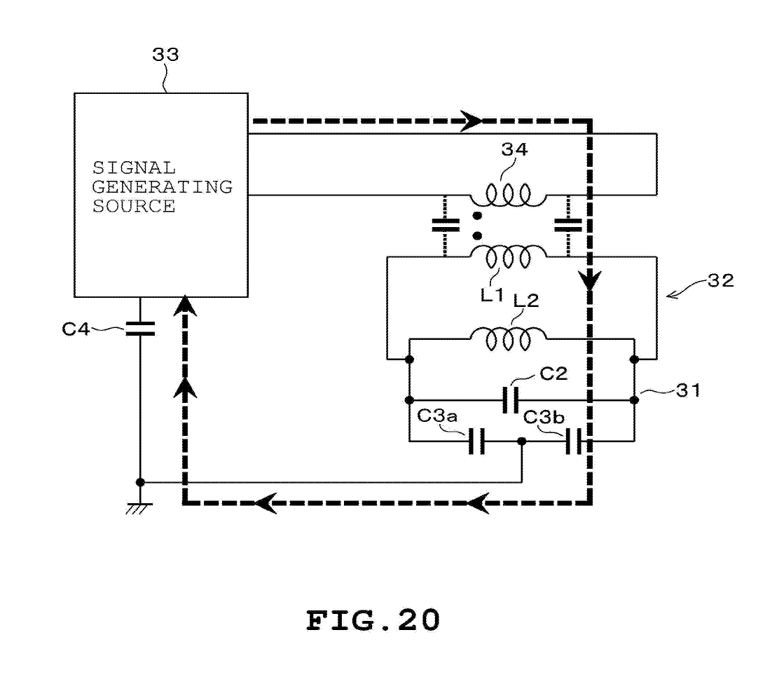

As shown in FIG. 20, in a third embodiment, a filter circuit 32 includes an LC parallel resonator 31 in which a series circuit of capacitors C3a and C3b is connected in parallel with an LC parallel resonator 12. In this case, the capacities of the capacitors C3a and C3b are set equal to each other with a common connection point serving as a neutral point connected to, for example, the ground. Thus, a predetermined potential is supplied.

A current-carrying coil 34 is connected between the output terminals of a signal generating source 33 and the ground terminal of the signal generating source 33 is connected to the ground via a capacitor C4. In this configuration, a coil L1 of the filter circuit 32 is electromagnetically coupled to the current-carrying coil 34. At this point, the presence of a parasitic capacitance between the current-carrying coil 34 and the coil L1 as indicated by broken lines in FIG. 20 may cause common mode noise along a path indicated by a dotted arrow in FIG. 20. In this case, the neutral point of the LC parallel resonator 31 can efficiently transfer common mode noise to the ground.

### Other Embodiments

A frequency, the constants of circuit elements, and the dimensions of a filter circuit may be optionally changed according to individual designs.

In the third embodiment, the predetermined potential is not limited to a ground potential. Moreover, the predetermined potential does not always need to be applied to the neutral point and one ends of the coil L2 and the capacitor C2 may be connected to the predetermined potential.

The present embodiment is not always applied to a wireless power transmission system and is also applicable to a wireless signal transmission system and a transmitter and a receiver of an electromagnetic signal.

The embodiments of the present embodiment are merely exemplary and are not intended to limit the scope of the embodiment. The new embodiments can be implemented in various other forms or can be omitted, replaced, and changed without departing from the spirit of the embodiment. The embodiments and modifications are included in the scope and spirit of the embodiment and are also included in embodiments described in claims and the equivalent range.

1. A filter circuit comprising:
a first coil electromagnetically coupled to a current-carrying coil inserted into a current flow path; and
a parallel circuit of a second coil and a capacitor, the parallel circuit being connecting across the first coil,
wherein element constants of the second coil and the capacitor are set such that parallel resonance occurs at a frequency where an impedance between terminals of the current-carrying coil is equivalent to an impedance of the current-carrying coil alone.

2. The filter circuit according to claim 1, wherein the second coil has an inductance that is set equal to or less than an inductance of the first coil.

3. The filter circuit according to claim 1, wherein the first coil is disposed on one side of a substrate while the current-carrying coil is disposed on the other side of the substrate.

4. The filter circuit according to claim 1, wherein the current-carrying coil is formed as one of an internal conductor and an external conductor of a coaxial cable, and
the first coil is formed as the other of the internal conductor and the external conductor.

5. The filter circuit according to claim 1, wherein the parallel circuit has a neutral point to which a predetermined potential is applied.

6. The filter circuit according to claim 2, wherein the parallel circuit has a neutral point to which a predetermined potential is applied.

7. The filter circuit according to claim 3, wherein the parallel circuit has a neutral point to which a predetermined potential is applied.

8. The filter circuit according to claim 4, wherein the parallel circuit has a neutral point to which a predetermined potential is applied.

9. A wireless power transmission system comprising:
a power transmitter comprising;
a power transmitting coil, and a filter circuit comprising
a first coil electromagnetically coupled to the power transmitting coil; and
a parallel circuit of a second coil and a capacitor, the parallel circuit being connected across the first coil,
wherein element constants of the second coil and the capacitor are set such that parallel resonance occurs at a frequency where an impedance between terminals of the power transmitting coil is equivalent to an impedance of the power transmitting coil alone;
a power receiver comprising;
a power receiving coil; and a filter circuit comprising
a first coil electromagnetically coupled to the power receiving coil; and
a parallel circuit of a second coil and a capacitor that are connected across the first coil,
wherein element constants of the second coil and the capacitor are set such that parallel resonance occurs at a frequency where an impedance between terminals of the power receiving coil is equivalent to an impedance of the power receiving coil alone.

10. The wireless power transmission system according to claim 9, wherein the second coil of the filter circuit has an inductance that is set equal to or less than an inductance of the first coil.

11. The wireless power transmission system according to claim 9, wherein the first coil of the filter circuit is disposed on one side of a substrate while the power transmitting coil and the power receiving coil are disposed on the other side of the substrate.

12. The wireless power transmission system according to claim 9, wherein the power transmitting coil and the power receiving coil are each formed as one of an internal conductor and an external conductor of a coaxial cable, and
the first coil of the filter circuit is formed as the other of the internal conductor and the external conductor.

13. The wireless power transmission system according to claim 9, wherein the parallel circuit of the filter circuit has a neutral point to which a predetermined potential is applied.

14. The wireless power transmission system according to claim 10, wherein the parallel circuit of the filter circuit has a neutral point to which a predetermined potential is applied.

15. The wireless power transmission system according to claim 11, wherein the parallel circuit of the filter circuit has a neutral point to which a predetermined potential is applied.

16. The wireless power transmission system according to claim 12, wherein the parallel circuit of the filter circuit has a neutral point to which a predetermined potential is applied.
